(19) United States
(12) Patent Application Publication
(10) Pub. No.: US 2007/0209855 A1
(43) Pub. Date: Sep. 13, 2007

(54) Motorcycle with suspension system that utilizes hubless wheels

(76) Inventor: Cezary T. Burkiewicz, Woodridge, IL (US)

Correspondence Address: BRIAN R. RAYVE, 161 MAPLE DRIVE, PARK CITY, UT, 84098, US

(21) Appl. No.: 11/170,755

(22) Filed: Jun. 29, 2005

(51) Int. Cl. B60B 19/00; B60B 27/00

(52) U.S. Cl. 180/223; 301/5.1; 301/6.8

(57) ABSTRACT

A centerless wheel assembly and suspension system for motorcycles. The wheel assembly includes a wheel rim with an annular body and outer flanges that define a tire receiving outer surface and one or more annular inner flanges. A ring-shaped wheel bearing includes one or more spaced bearing ring pairs with first and second bearing rings each defining annular bearing race. One of the inner flanges closely fits disposed within each bearing races to retain a plurality of ball and/or roller bearings therein to rotatably support the wheel rim. The wheel assembly may include a mounting ring which connects to the wheel rim and a toothed drive ring to engage a drive chain of the motorcycle.

### BACKGROUND OF THE INVENTION

1. Field

The present invention generally relates to motorcycles, and more specifically to wheels and suspension systems for motorcycles.

2. State of the Art

Motorcycles have used suspension systems that have not changes significantly over the years. They typically utilize spoked wheel hubs similar to that of bicycles, or more recently, solid wheel hubs of cast aluminum that is machined to a finished configuration. The front forks connected to the handle bars used for steering motorcycles are typically connected to the center of the wheel hubs. The wheel hubs add significant weight to the motorcycle and centrifugal force creates a gyroscopic effect when moving that provides stability for the motorcycle such as during turning but at the expense of maneuverability thereof.

More recently, several hubless wheels have been patented for motorcycles and for bicycles. For example, in U.S. Pat. No. 5,071,196 issued to Sbarro on Dec. 10, 1991 is disclosed a wheel for motor vehicles. The wheel includes a swing arm that rollably supports a wheel rim with a large diameter bearing disposed therebetween. The bearing includes an inner bearing race affixed to the swing arm and an outer bearing race affixed to the wheel rim. A rubber tire is mounted to the wheel rim. The swing arm is pivotally connected to a main structure of the motor vehicle. The outer race of the bearing includes an annular braking ring which is selectively engaged by braking jaws mounted to the swing arm to provide a braking function.

In U.S. Pat. No. 5,248,019 issued to Sbarro on Sep. 28, 1993 is disclosed a hubless motorcycle which includes a front wheel fitted with a first crown-shaped roller bearing. The bearing includes an outer bearing race that supports a wheel rim and an inner bearing race that is connected to a swing arm. The swing arm carries at a front end thereof a second crown-shaped roller bearing affixed to the inner bearing race. The motorcycle allows to transmit the steering forces to a rubber tire mounted to the wheel rim at a point located close to the ground surface.

In U.S. Pat. No. 6,224,080 issued to Ross on May 1, 2001 is disclosed a bicycle having spokeless wheels. The bicycle includes a frame having a seat and handle bars, a rear bracket with rear bearings that rotatably engage a rear wheel, a front bracket having front bearings that rotatably engages a front wheel, and a pedal operated drive train that engages and drives the rear wheel. A wheel rim of the rear wheel includes a rear groove that receives the plurality of rear bearings. The wheel rim of the rear wheel includes a gear that is engaged by a drive sprocket of the drive train. A wheel rim of the front wheel includes a front groove that receives the plurality of front bearings.

### SUMMARY OF THE INVENTION

The present invention is a centerless wheel assembly for motorcycles, a motorcycle with a suspension system that includes a pair of the wheel assemblies, and the suspension system for use on motorcycles.

The wheel assembly includes a ring-shaped wheel rim having an annular body and a pair of annular outer flanges radially outwardly dependent from the body which define an annular tire receiving outer surface. A ring-shaped wheel bearing is rotatably retained within the wheel rim which together define an annular bearing race adapted to contain a plurality of bearing members to rotatably support the front wheel rim on the wheel bearing. The wheel bearing is adapted to mount to the motorcycle through a shock absorber of the motorcycle to allow upward and downward movement of the wheel assembly against the shock absorber responsive to road contours.

The wheel assembly may include a drive assembly which includes a mounting ring having an outer periphery adapted to connect to a mounting shoulder of the wheel rim. A drive ring is coaxially affixed to the mounting ring in a laterally spaced relation thereto having an outer periphery. The outer periphery has a toothed, a v-belt groove, or a toothed pulley groove adapted to engage a drive loop of the motorcycle respectively in the form of a chain, a v-belt, and a toothed drive belt to drive the wheel rim.

In a preferred wheel assembly, the wheel bearing is adapted to mount to the motorcycle and allow movement of the wheel assembly in a manner of either: 1) fixedly mounted disposed closely adjacent to the wheel rim and operatively mounted to the shock absorber to allow linear movement; 2) pivotally mounted at a main pivot disposed closely adjacent to the wheel rim and operatively mounted to the shock absorber at a secondary pivot to allow pivotal movement; 3) fixedly mounted to a pivotable swing arm of the motorcycle disposed closely adjacent to the wheel rim that is operatively mounted to the shock absorber to allow pivotal movement; and 4) fixedly mounted to a pivotable swing arm of the motorcycle disposed closely adjacent to the wheel rim that is adapted to operatively mount to the shock absorber at a secondary pivot to allow pivotal movement.

The wheel bearing of the preferred wheel assembly includes one or more bearing ring pairs comprised of respective first and second bearing rings that connect together rotatably retained within the wheel rim with the bearing race and one of the plurality of bearing members disposed therebetween. The number of bearing rings preferably is either a single bearing ring pair or two bearing ring pairs. The wheel bearing which includes two has the bearing ring pairs retained in a laterally spaced position using a plurality of spacers disposed therebetween. The wheel rim has an annular inner flange for each bearing ring pair radially inwardly dependent from the body. The inner flange is adapted to closely fit at least partially disposed within respective of the bearing races to retain respective of the bearing members therein. The first and second bearing rings of each bearing ring pair preferably have the first bearing ring comprising a plate ring of rectangular cross-section and the second bearing ring comprising a flange ring of L-shaped cross-section. In this case, the flange ring preferably has an outer leg and a base leg which together with the plate ring define the bearing race. Alternatively, the first bearing ring preferably comprises a flange ring of Z-shaped cross-section which includes an outer leg, an intermediate leg, and a base leg which together with the wheel rim define an annular roller race. The roller race is adapted to contain a plurality of the bearing members in the form of rollers. The bearing race in the form of a ball race is adapted to contain a plurality of the bearing members in the form of ball bearings. In this case, the second bearing ring comprises a flange ring of L-shaped cross-section which includes an outer leg and a base leg which together with the wheel rim define an annular second ball race abutting the roller race adapted to contain a plurality of the ball bearings.

The preferred wheel assembly may include a brake unit which includes a brake housing adapted to transversely mount to the wheel bearing. At least one brake cylinder is mounted to the housing operated through a hydraulic brake line of the motorcycle. A pair of brake pads straddle a brake ring radially inwardly dependent from the body of the wheel rim. The brake ring may be disposed in a lateral orientation on the wheel rim of centered or offset. The brake pads are operatively associated with the housing and the brake cylinders to selectively apply braking force to the brake ring of the wheel rim.

The motorcycle includes a support frame which has a front end with a steering bearing unit mounted thereto and a rear end. A pair of handle bars are upwardly dependent from a pivot post pivotally disposed through the bearing unit. A front suspension includes at least one fork tube downwardly dependent from the pivot post and at least one front shock absorber. A rear suspension is pivotally mounted to the rear end of the support frame which includes a rear shock absorber. A front wheel assembly of the type described is adapted to mount to the fork tube through the front shock absorber to allow movement of the front wheel assembly thereagainst responsive to road contours. A rear wheel assembly of the type described is adapted to mount to the rear end of the support frame through the rear shock absorber to allow movement of the rear wheel assembly thereagainst responsive to road contours. Respective front and rear tires are mounted to the front and rear wheel rims at the tire receiving outer surfaces. An engine with gear box are centrally mounted to the support frame adapted to drive the rear wheel assembly and the rear tire through a drive assembly. A hydraulic brake system which includes respective front and rear hydraulic brake lines. A gas tank is mounted to the support frame to supply fuel to the engine, and a seat is mounted to support frame for a rider to sit on.

In a first preferred motorcycle, the front suspension includes a pair of the fork tubes each of which comprise a pair of upper and lower fork tubes. The upper and lower fork tubes telescope together straddling opposite sides of the front wheel assembly and the front tire. Respective lower ends of the lower fork tubes are fixedly mounted to the front wheel bearing disposed closely adjacent to the front wheel rim. There are a pair of the front shock absorbers at least a portion of each being disposed within respective of the pairs of fork tubes. Opposite ends of the front shock absorber are connected to the upper and lower fork tubes of the fork tube pair to allow generally vertically oriented linear movement of the front wheel assembly responsive to road contours that is controlled by the front shock absorbers. The lower ends of the lower fork tubes may be directly affixed to the front wheel bearing by inwardly bending and at least partially flattening the lower ends which are affixed directly to the front wheel bearing. Alternatively, the lower ends of the lower fork tubes may % be indirectly using at least one mounting block affixed to the lower ends and to the front wheel rim.

In a second and a third preferred motorcycle, the front suspension includes a support fender comprised of a curved outer wall closely disposed radially outwardly of the front tire and a pair of dependent side walls laterally disposed along the front tire. The outer wall is adapted to pivotally connect to a first end of the front shock absorber. Another part of the front suspension is adapted to pivotally connect to a second end thereof. Each of the side walls has a main pivot and a secondary pivot respectively coaxially disposed through respective lower and an upper ends thereof. The front wheel bearing has main and secondary pivots disposed closely adjacent to the front wheel rim. The main pivots of each pivotally connect together and the secondary pivots connect together. This allows generally vertically oriented pivotal movement of the support fender and the front wheel assembly responsive to road contours that is controlled by the front shock absorber.

In the second preferred motorcycle, the front suspension includes a pair of the fork tubes interconnected by a mounting member to which the second end of the front shock absorber is pivotally connected. The fork tubes terminate at respective lower ends having a pair of the main pivots coaxially disposed therethrough.

In the third preferred motorcycle, the front suspension includes a front extension which extends forwardly from the front end of the support frame. The fork tube includes an upper end connected to the pivot post through a first universal joint. A steering yoke of generally Y-shape is disposed generally horizontally at the front extension. The steering yoke includes a base leg pivotally connected thereto using a bearing. A pair of dependent forked legs straddle opposite sides of the front wheel assembly. The lower end of the fork tube is connected to the base of the steering yoke through a second universal joint coaxial with the bearing. The second end of the front shock absorber is pivotally connected to the steering yoke. The forked legs terminate at respective distal ends having a pair of the main pivots coaxially disposed therethrough.

In a fourth and a fifth preferred motorcycle, the rear suspension includes a pivoting swing arm having a front end pivotally mounted to the rear end of the support frame at respective main pivots of each. The swing arm extends generally horizontally rearwardly along a side of the rear wheel assembly opposite the drive assembly. A rear end of the swing arm is fixedly mounted to the rear wheel bearing disposed closely adjacent to the rear wheel rim. The swing arm is adapted to pivotally connect to a first end of the rear shock absorber. The rear end of the support frame is adapted to pivotally connect to a second end of the rear shock absorber to allow generally vertically oriented pivotal movement of the rear swing arm and the rear wheel assembly responsive to road contours that is controlled by the rear shock absorber.

In the fourth preferred motorcycle, the swing arm is of a straight configuration comprising a first version pivot arm having the front end pivotally mounted to the support frame and the rear end is fixedly mounted to the rear wheel bearing. The pivot arm is adapted to pivotally connect to the rear shock absorber.

In the fifth preferred motorcycle, the swing arm is of an angled configuration comprising a second version pivot arm having the front end pivotally mounted to the support frame and the rear end fixedly mounted to the rear wheel bearing. A drive arm is dependent therefrom at an angle adapted to pivotally connect to the rear shock absorber.

In a sixth preferred motorcycle, the rear wheel bearing has respective main and secondary pivots disposed closely adjacent to the rear wheel rim. A rear extension of the rear suspension extends rearwardly from the rear end of the support frame along a side of the rear wheel assembly opposite the drive assembly. The rear extension is pivotally mounted to the main pivot of the rear wheel bearing at a lower frame pivot. The rear shock absorber extends along the side of the rear wheel assembly above the drive assembly. The rear shock absorber has a first end that is pivotally mounted to the secondary pivot of the rear wheel bearing. A second end of the rear shock absorber is pivotally mounted to a part of the motorcycle, either the rear end of the support frame or the rear extension of the rear suspension at an upper frame pivot disposed generally above the lower frame pivot.

### THE DRAWINGS

The best mode presently contemplated for carrying out the invention is illustrated in the accompanying drawings, in which:

FIG. 1 is a side elevational view of a first embodiment motorcycle which includes a first version front suspension and a first version rear suspension;

FIG. 2, a fragmentary side elevational view of the first version front suspension system showing a support fender, a front shock absorber, a front wheel bearing, and a front wheel rim thereof;

FIG. 3, a lateral vertical sectional view through the front wheel bearing and the front wheel rim taken on the line 3-3 of FIG. 2;

FIG. 4, a fragmentary side elevational view of the first version rear suspension system showing a rear shock absorber, a rear wheel bearing, and a rear wheel rim thereof;

FIG. 5, a lateral vertical sectional view through the rear wheel bearing and the rear wheel rim taken on the line 5-5 of FIG. 4;

FIG. 6, a side elevational view of a second embodiment motorcycle which includes a second version front suspension and a second version rear suspension;

FIG. 7, a fragmentary side elevational view of the second version front suspension system showing a telescoping fork tubes, the front shock absorber, the front wheel bearing, and the front wheel rim thereof;

FIG. 8, a fragmentary side elevational view of the second version rear suspension system showing a swing arm, the rear shock absorber, the rear wheel bearing, and the rear wheel rim thereof;

FIG. 9 a side elevational view of a third embodiment motorcycle which includes a third version front suspension and a third version rear suspension;

FIG. 10, a fragmentary side elevational view of the third version front suspension system showing a pivoting fork tube with universal joint, a steering yoke, the front shock absorber, the front wheel bearing, and the front wheel rim thereof;

a fragmentary side elevational view of the second version rear suspension system showing a swing arm, the rear shock absorber, the rear wheel bearing, and the rear wheel rim thereof;

FIG. 11 a fragmentary side elevational view of the third version rear suspension system showing a swing arm, the rear shock absorber, a wider rear wheel bearing, and a wider rear wheel rim thereof; and

FIG. 12, a lateral vertical sectional view through the rear wheel bearing and the rear wheel rim taken on the line 12-12 of FIG. 11.

### DETAILED DESCRIPTION OF THE ILLUSTRATED EMBODIMENTS

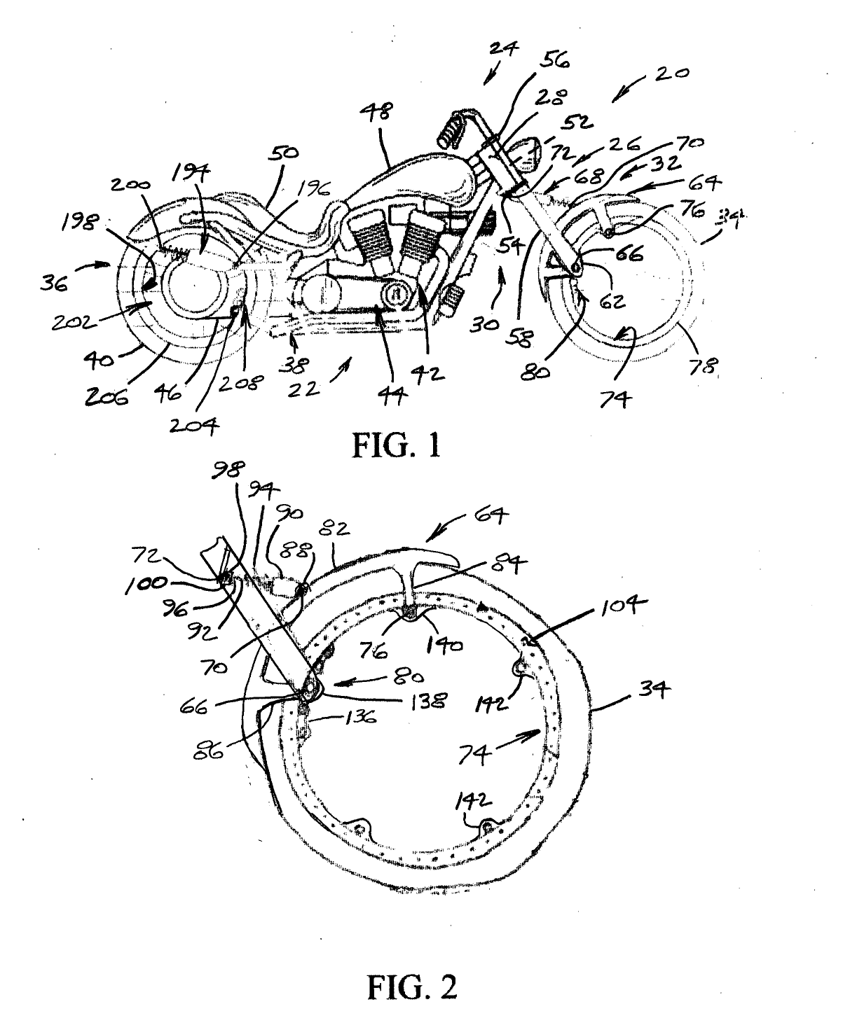

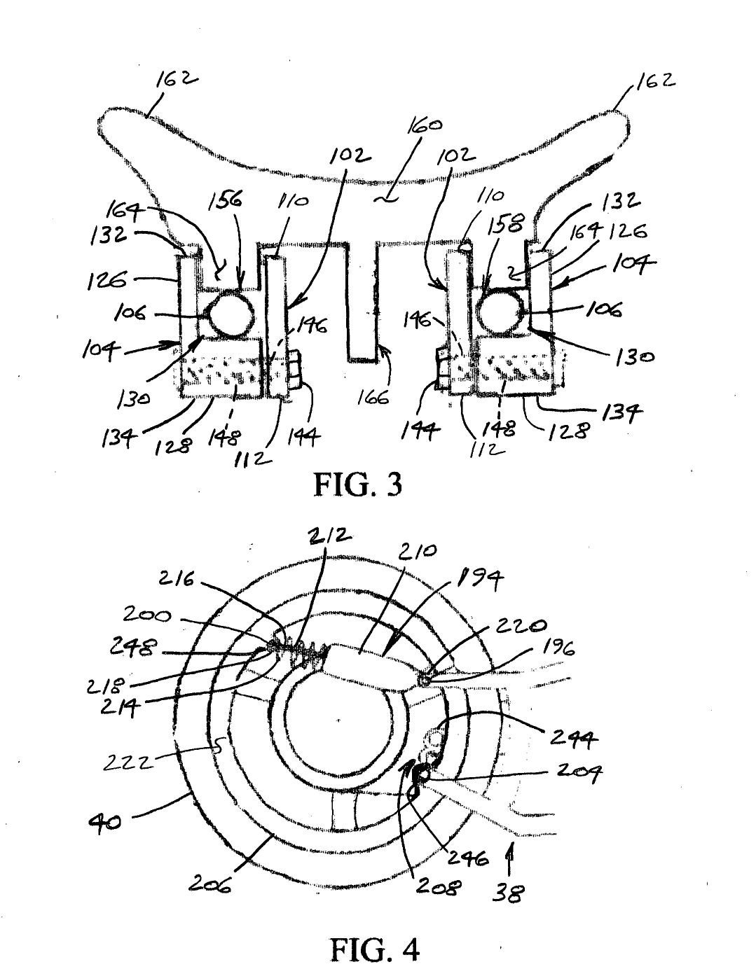

Referring to FIG. 1, therein is shown a first embodiment motorcycle of the present invention, designated generally at 20. The motorcycle 20 includes a support frame 22, handle bars 24 dependent from a front fork 26 pivotally mounted through a bearing unit 28 at a front end 30 of the support frame 22, a first version front suspension 32 pivotally mounted to the front fork 26 supported on a front tire 34, a first version rear suspension 36 pivotally mounted to a rear end 38 of the support frame 22 supported on a rear tire 40, a two cylinder engine 42 and gear box 44 centrally mounted to the support frame 22 that drive the rear tire 40 through a drive belt or chain 46, a gas tank 48 mounted to support frame 22 above the engine 42 to supply gas thereto, and a contoured seat 50 mounted to support frame 22 behind the gas tank 48 for a rider (not shown) to sit on.

The front fork 26 includes a pivot post 52 that extends upwardly from a lower support plate 54 through the bearing unit 28 at the front end 30 of the support frame 22 and is connected to the handle bars 24 through an upper support plate 56. A pair of fork tubes 58 are downwardly dependent from lower support plate 54 with a transverse mounting plate 60 interconnecting respective lower ends 62 thereof.

The front suspension 32 includes a support fender 64 pivotally mounted to the lower ends 62 of the fork tubes 58 using a first pivot bolt 66, a front shock absorber 68 pivotally mounted to the support fender 64 using a second pivot bolt 70 and to the mounting plate 60 of front fork 26 using a third pivot bolt 72, an annular front wheel bearing 74 pivotally mounted to the lower ends 62 of the fork tubes 58 and the support fender 64 using the first pivot bolt 66 and to the support fender 64 at a fourth pivot bolt 76 that rotatably supports a front wheel rim 78 thereabout, and a front brake unit 80 mounted to the front wheel bearing 74 to selectively apply braking force to the front wheel rim 78.

The support fender 64 is typically punched out and formed from sheet steel or aluminum. Support fender 64 includes a curved body 82, a pair of front tabs 84, a pair of rear tabs 86, and a pair of top tabs 88. The first pivot bolt 66 extends through the rear tabs 86 to pivotally mount to the lower ends 62 of the fork tubes 58. The fourth pivot bolt 76 extends through the front tabs 84 to pivotally mount to the front wheel bearing 74. The second pivot bolt 70 extends through the top tabs 88 to pivotally mount to the front shock absorber 68.

The front shock absorber 68 is of conventional design including a cylindrical body 90, a piston rod 92 linearly movable in the body 90, and a compression spring 94 disposed about the piston rod 92. The piston rod 92 has a distal end 96 with a mounting tab 98 through which the second pivot bolt 70 extends to pivotally mount to the support fender 64. The body 90 has a mounting tab 100 through which the third pivot bolt 72 extends to pivotally mount to the mounting plate 60 of the front fork 26.

The front wheel bearing 74 includes a pair of annular plate rings 102, a pair of annular flange rings 104, a plurality of ball bearings 106, and a plurality of tubular spacers 108. The plate rings 102 each have an outer periphery 110 which fits within the front wheel rim 78, an inner periphery 112 with a plurality of brake mounting pads 114, a main pivot pad 116, a fender mounting pad 118, and a plurality of spacer pads 120. The plate rings 102 are each split into a pair of half rings 122 and 124 to facilitate assembly to the front wheel rim 78. The flange rings 104 are each of L-shaped cross-section having an outer leg 126 and a base leg 128 which define a ball space 130. The flange rings 104 have an outer periphery 132 which fits within the front wheel rim 78, an inner periphery 134 with a plurality of brake mounting pads 136, a main pivot pad 138, a fender mounting pad 140, and a plurality of spacer pads 142. The plate rings 102 are connected to respective of the flange rings 104 using a plurality of bolts 144 that extend through clearance holes 146 through the plate rings 102 and engage threaded holes 148 of the flange rings 104. The bolted together pairs of the plate rings 102 and the flange rings 104 are connected together using a plurality of bolts 150 that extend through clearance holes 152 through the plate rings 102 and flange rings 104, and through the spacers 108 and retained using respective nuts 154 to form a pair of annular ball races 156 and 158 to contain the ball bearings 106. The front wheel bearing 74 is pivotally mounted to the lower ends 62 of the fork tubes 58 and to the rear tabs 86 of the support fender 64 using the first pivot bolt 66 which extends through the main pivot pads 116 and 138 respectively of the plate rings 102 and the flange rings 104. The front wheel bearing 74 is pivotally mounted to the front tabs 84 of the support fender 64 using the fourth pivot bolt 76.

The front wheel rim 78 includes an annular body 160, respective dependent annular outer flanges 162, respective dependent annular inner flanges 164 which fit within respective of the ball races 156 and 158 to retain the ball bearings 106 therein, and a dependent brake ring 166. The front wheel rim 78 is made of cast aluminum that is machined to final configuration.

The front brake unit 80 includes a brake housing 168, a pair of brake cylinders 170, and a pair of brake pads 172. The brake housing 168 slidably mounts to the brake mounting pads 114 and 136 of the plate rings 102 and the flange rings 104 at respective mounting pads 174 of the brake housing 168 on a plurality of bolts 176 that extend through clearance holes 178 and bushings 180 thereof and of mounting pads 114 and 136 into respective threaded holes 182 of the mounting pads 140 of flange rings 104. The brake pads 172 straddle the brake ring 166 of front wheel rim 78 with the brake cylinders 170 selectively applying braking force to the front wheel rim 78 in conventional manner through a front hydraulic brake line 182.

The rear end 38 of the support frame 22 includes a pair of upper frame tubes 186 which terminate rearwardly at respective cantilevered upper mounting ends 188 and a pair of lower frame tubes 190 which terminate rearwardly at respective cantilevered lower mounting ends 192.

The rear suspension 36 includes a rear shock absorber 194 pivotally mounted to respective of the upper mounting ends 188 of upper frame tubes 186 using a fifth pivot bolt 196 and to an annular rear wheel bearing 198 using respective sixth pivot bolts 200, and a spoked drive sprocket 202 mounted to the rear wheel bearing 198. The rear wheel bearing 198 is pivotally mounted to respective of the lower mounting ends 192 of lower frame tubes 190 using respective seventh pivot bolts 204 to rotatably support a rear wheel rim 206 thereabout. The rear wheel bearing 198 is pivotally mounted to the rear end 38 of support frame 22 using a seventh pivot bolt 204. A rear brake unit 208 is mounted to the rear wheel bearing 198 to selectively apply braking force to the rear wheel rim 206.

The rear shock absorber 194 is of conventional design each including a cylindrical body 210, a piston rod 212 linearly movable in the body 210, and a compression spring 214 disposed about the piston rod 212. The piston rod 212 has a distal end 216 with a mounting tab 218 through which a sixth pivot bolt 200 extends to pivotally mount to the rear wheel bearing 198. The body 210 has a mounting tab 220 through which the fifth pivot bolts 196 extends to pivotally mount to respective of the upper mounting ends 188 of upper frame tubes 186.

The rear wheel bearing 198 includes a pair of annular flange rings 222 and 224, a plurality of roller bearings 226, and a plurality of ball bearings 228. The flange ring 222 has an outer leg 230, an intermediate leg 232, and a base leg 234 which define a roller space 236 and a ball space 238. The flange ring 222 has an outer periphery 240 which fits within the rear wheel rim 206, an inner periphery 242 with a plurality of brake mounting pads 244, a main pivot pad 246, and a shock absorber mounting pad 248. The flange ring 224 has an outer leg 250 and a base leg 252 which define a ball space 254 and abuts the roller space 236. The flange ring 224 has an outer periphery 256 which fits within the rear wheel rim 206, an inner periphery 258 with a plurality of brake mounting pads 260, a main pivot pad 262, and a shock absorber mounting pad 264. The flange rings 222 and 224 are connected together using a plurality of bolts 266 that extend through clearance holes 268 through the flange ring 222 and engage threaded holes 270 of the flange ring 224 to form an annular roller race 272 to contain the roller bearings 226 and a pair of annular ball races 274 and 275 to contain the ball bearings 228. The rear wheel bearing 198 is pivotally mounted to the lower mounting ends 192 of lower frame tubes 190 using the seventh pivot bolts 204 which extend through the main pivot pads 246 and 262 of flange rings 222 and 224. The rear wheel bearing 198 is pivotally mounted to the mounting tab 218 of the rear shock absorber 194 using the sixth pivot bolt 200 which extends through the shock absorber mounting pads 248 and 264.

The rear wheel rim 206 includes an annular body 276, respective dependent annular outer flanges 278, a dependent annular inner flange 280 which abuts respective of the ball races 274 and 275 to retain the ball bearings therein and abuts the roller race 272 to support the rear wheel rim 206, and a drive sprocket recess 282 with a mounting shoulder 284. The rear wheel rim 206 is made of cast aluminum that is machined to final configuration.

The drive sprocket 202 includes a sprocket plate ring 286 and a brake ring 288 connected thereto by a hub 290 and spokes 292. The sprocket plate ring 286 has a toothed outer periphery 294 which engages the drive chain 46 and an inner periphery 296 affixed to the hub 290. The brake ring 288 has an outer periphery 298 which is connected to the mounting shoulder 284 using a plurality of bolts 300 that extend through respective clearance holes 302 thereof and engage respective threaded holes 304 of the flange ring 224. The brake ring 288 has an inner periphery 306 affixed to the spokes 292 which are affixed to the hub 290.

The rear brake unit 208 includes a brake housing 308, a pair of brake cylinders 310, and a pair of brake pads 312. The brake housing 308 slidably mounts to the brake mounting pads 244 and 260 of the flange rings 222 and 224 at respective mounting pads 314 of the brake housing 308 on a plurality of bolts 316 that extend through clearance holes 318 and bushings 320 thereof and of brake mounting pads 244 of flange ring 222 into respective threaded holes 322 of the mounting pads 260 of flange ring 224. The brake pads 312 straddle the brake ring 288 of drive sprocket 202 with the brake cylinders 310 selectively applying braking force to the rear wheel rim 206 in conventional manner through a rear hydraulic brake line 324.

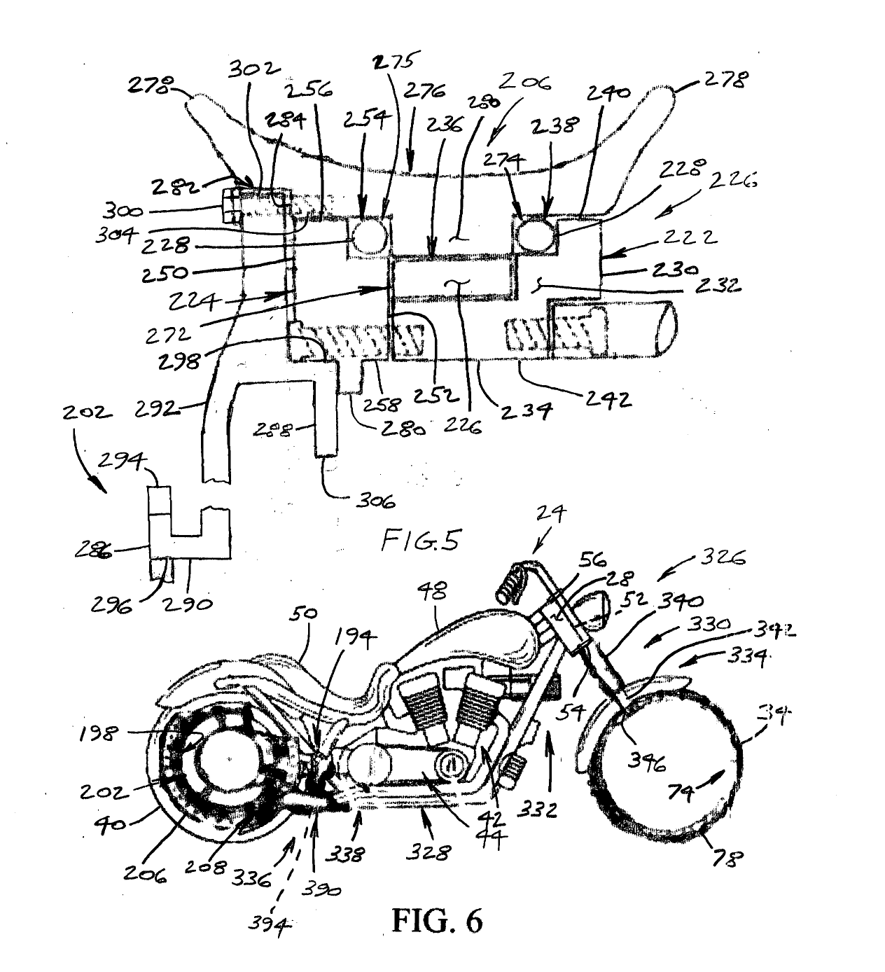

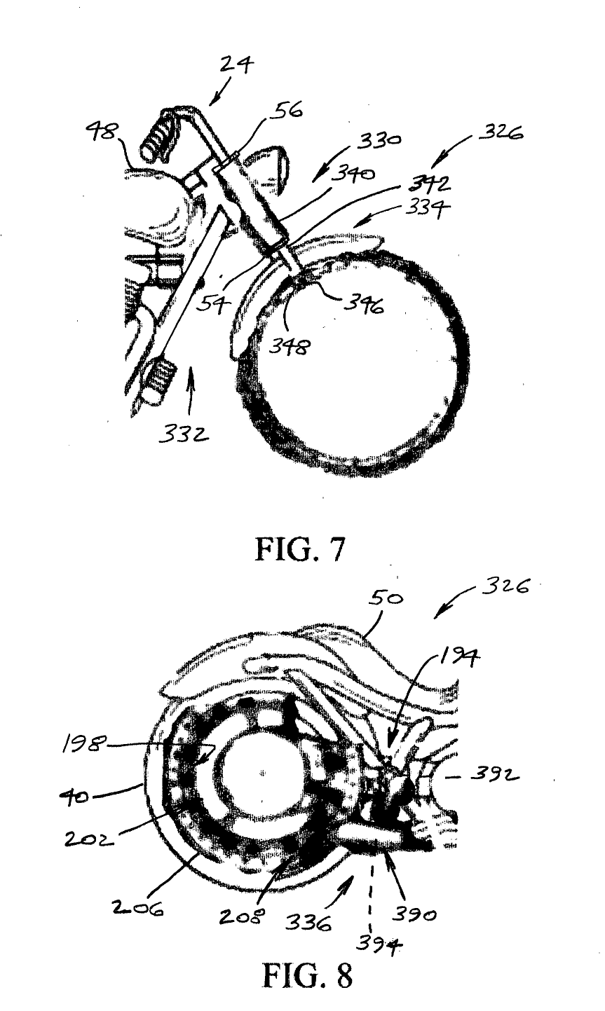

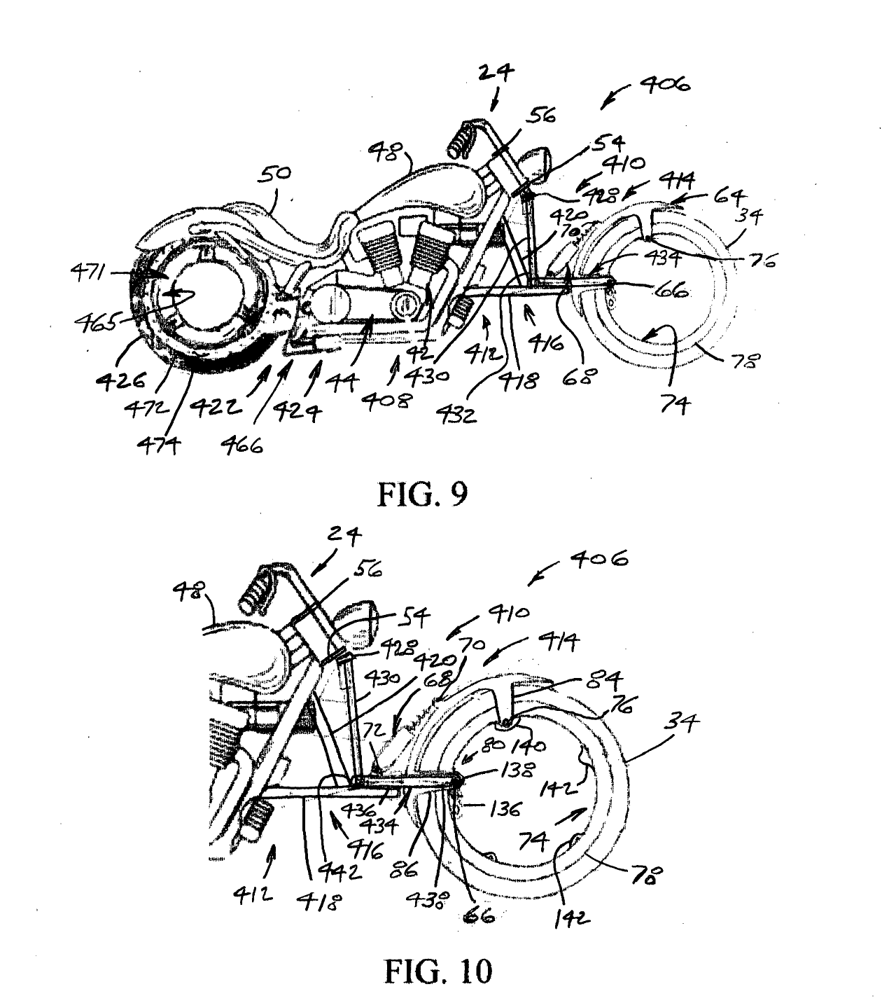

Referring to FIG. 6, therein is shown a second embodiment motorcycle 326. The motorcycle 326 includes a modified support frame 328, the handle bars 24 dependent from a front fork 330 pivotally mounted through the bearing unit 28 at a front end 332 of the support frame 328, a second version front suspension 334 pivotally mounted to the front fork 330 supported on the front tire 34, a second version rear suspension 336 pivotally mounted to a rear end 338 of the support frame 328 supported on the rear tire 40, the two cylinder engine 42 and gear box 44 centrally mounted to the support frame 328 that drive the rear tire 40 through the drive chain 46, the gas tank 48 mounted to support frame 328 above the engine 42 to supply gas thereto, and the contoured seat 50 mounted to support frame 328 behind the gas tank 48 for the rider (not shown) to sit on.

The front fork 330 includes the pivot post 52 that extends upwardly from the lower support plate 54 through the bearing unit 28 at the front end 332 of the support frame 328 and is connected to the handle bars 24 through the upper support plate 56. A pair of upper fork tubes 340 are downwardly dependent from lower support plate 54.

The front suspension 334 includes a pair of lower fork tubes 342 that telescope into the upper fork tubes 340 through a pair of bushings 344 that terminate at respective lower ends 346, a pair of the front shock absorbers 68 mounted within respective of the upper fork tubes 340, the annular front wheel bearing 74 mounted to the lower ends 346 of the lower fork tubes 342 using a pair of mounting blocks 348 that rotatably supports the front wheel rim 78 thereabout, and the front brake unit 80 mounted to the front wheel bearing 74 to selectively apply braking force to the front wheel rim 78.

Mounting blocks 348 each have a plurality of clearance holes 350 therethrough to receive respective long bolts 352 therethrough that engage the threaded holes 182 of the mounting pads 140 of flange ring 104. The lower ends 346 of lower fork tubes 342 are disposed in respective fork tube bores 354 that extend partially through each mounting block 348. Each lower fork tube 342 is affixed therein by a pair of bolts 356 that extend through respective clearance holes 358 of the mounting block 348, through a pair of clearance holes 360 through the lower fork tube 342, which engage respective threaded holes 362 thereof. Alternatively, the mounting blocks 348 may be welded to or integral with the lower fork tubes 342.

The mounting tab 100 of the body 90 of each front shock absorber 68 is mounted to respective of the upper fork tubes 340 using respective bolts 364 that extend through clearance holes 366 therethrough, through a pair of tubular spacers 368, and through the mounting tabs 100, being secured using respective lock nuts 370. The mounting tab 98 of the piston rod 92 of each front shock absorber 68 is mounted to respective of the lower fork tubes 342 using respective of bolts 364 that extend through clearance holes 372 therethrough, through a pair of the tubular spacers 368, and through the mounting tab 98, being secured using respective of lock nuts 370. The front shock absorbers 68 control telescoping of the upper and lower fork tubes 340 and 342.

The front wheel bearing 74 includes the pair of annular plate rings 102, the pair of annular flange rings 104, the plurality of ball bearings 106, and the plurality of tubular spacers 108. The main pivot pads 116 and 138, and the fender mounting pads 118 and 140 respectively of the plate rings 102 and the flange rings 104 are not utilized and may be eliminated as indicated by being shown in dotted outline.

The front wheel rim 78 includes the annular body 160, the dependent annular outer flanges 162, the dependent annular inner flanges 164, and the brake ring 166.

The front brake unit 80 includes the brake housing 168, the brake cylinders 170, and the brake pads 172. The brake pads 172 selectively apply braking force to the front wheel rim 78 in conventional manner through the front hydraulic brake line 182.

The rear end 338 of the support frame 328 includes a pair of upper frame tubes 376 which bend rearwardly downwardly terminating at respective upper mounting ends 378 and a pair of lower frame tubes 380 which terminate rearwardly at respective lower mounting ends 382 welded to the upper mounting ends 378 with a transverse swing arm pivot tube 384. The upper frame tubes 376 are interconnected by a shock absorber upper mounting plate 386 with a pair of shock absorber mounting tabs 388.

The rear suspension 336 includes the annular rear wheel bearing 198, a swing arm 390 affixed thereto and pivotally mounted to the support frame 328 at the pivot tube 384, the rear shock absorber 194 is pivotally mounted to the mounting tabs 388 of the shock absorber mounting plate 386 using an eighth pivot bolt 392 and to the swing arm 390 using a ninth pivot bolt 394, and the spoked drive sprocket 202 is mounted to the rear wheel bearing 198 to rotatably support the rear wheel rim 206 thereabout. The rear brake unit 208 is mounted to the rear wheel bearing 198 to selectively apply braking force to the rear wheel rim 206.

The swing arm 390 includes a solid body 396 with a pair of shock absorber mounting tabs 398. The swing arm 390 has respective bushings 400 through a pivot bore 402 thereof to receive the seventh pivot bolt 204 which extends through the swing arm pivot tube 384. The rear wheel bearing 198 is mounted to the swing arm 390 using a pair of mounting blocks 404.

The rear wheel bearing 198 includes the annular flange rings 222 and 224, the roller bearings 226, and the ball bearings 228.

The rear wheel rim 206 includes the body 276, the outer flanges 278, the inner flange 280, and the drive sprocket recess 282 with the mounting shoulder 284.

The drive sprocket 202 includes the sprocket plate ring 286 which engages the drive chain 46 and the brake ring 288 connected thereto by the hub 290 and spokes 292.

The rear brake unit 208 includes the brake housing 308, the brake cylinders 310, and the brake pads 312. The brake pads 312 selectively apply braking force to the rear wheel rim 206 in conventional manner through the rear hydraulic brake line 324.

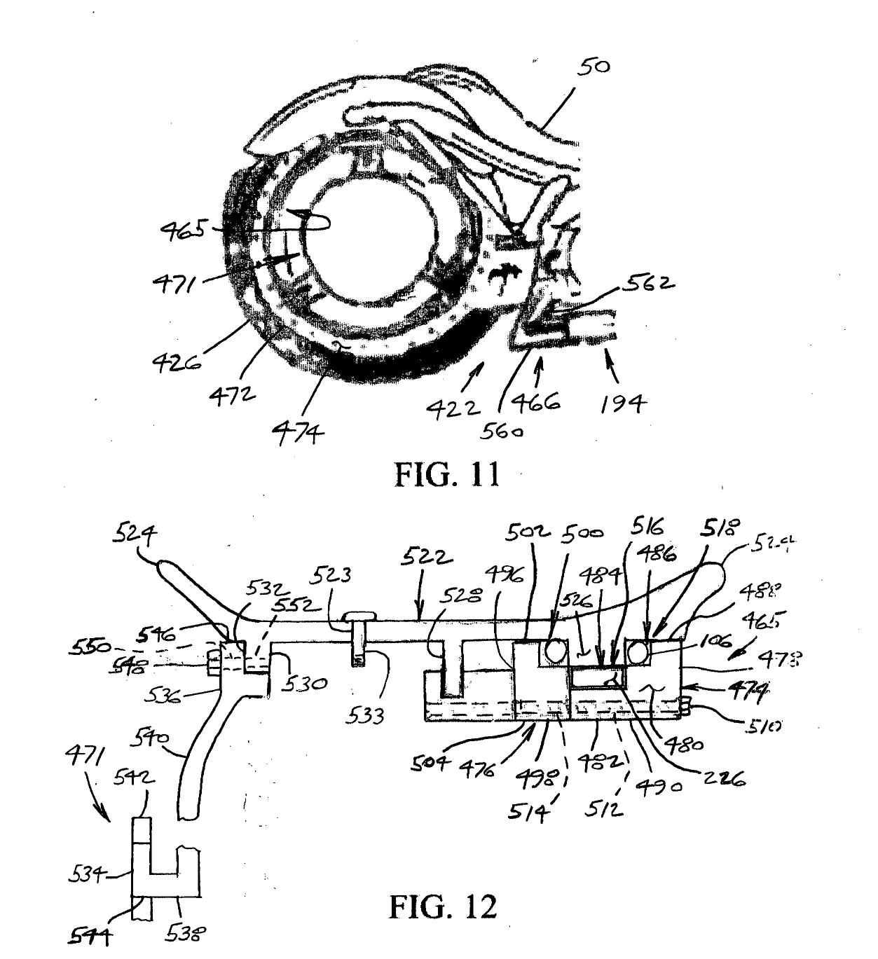

Referring to FIG. 11, therein is shown a third embodiment motorcycle 406. The motorcycle 406 includes a support frame 408, the handle bars 24 dependent from a front fork 410 pivotally mounted through the bearing unit 28 at a front end 412 of the support frame 408, a third version front suspension 414 pivotally mounted to the front fork 410 and a front extension 416 of support frame 408 that includes a horizontal tube 418 and a vertical tube 420 supported on the front tire 34, a third version rear suspension 422 pivotally mounted to a rear end 424 of the support frame 408 supported on a wider rear tire 426, the two cylinder engine 42 and gear box 44 centrally mounted to the support frame 408 that drive the rear tire 426 through the drive chain 46, the gas tank 48 mounted to support frame 408 above the engine 42 to supply gas thereto, and the contoured seat 50 mounted to support frame 408 behind the gas tank 48 for the rider (not shown) to sit on.

The front fork 410 includes the pivot post 52 that extends upwardly from a universal joint 428 through the bearing unit 28 at the front end 412 of the support frame 408 and is connected to the handle bars 24 through the upper support plate 56. A single fork tube 430 is downwardly dependent from universal joint 428 having a lower end 432. A steering yoke 434 of Y-shape includes a base leg 436 and a pair of dependent forked legs 438. A pair of shock absorber mounting tabs 440 extend from the base leg 436. The base leg 436 is pivotally connected to the horizontal tube 418 of support frame 408 using a bearing assembly 442 that includes a steering bearing 444 retained in a casting 446 affixed to the horizontal tube 418 of support frame 408. The lower end 432 of fork tube 430 is affixed to the base leg 436 of steering yoke 434 coaxial with the steering bearing 444.

The front suspension 414 includes the support fender 64 and the annular front wheel bearing 74 pivotally mounted to the front tabs 84 of the support fender 64 using the fourth pivot bolt 76, the front shock absorber 68 pivotally mounted to the rear tabs 86 of support fender 64 using the second pivot bolt 70 and to the mounting tabs 446 of steering yoke 434 using the third pivot bolt 72, the rear tabs 86 of support fender 64 and the front wheel bearing 74 pivotally mounted to the forked legs 438 of steering yoke 434 using the first pivot bolt 66, and the front brake unit 80 mounted to the front wheel bearing 74 to selectively apply braking force to the front wheel rim 78.

The front wheel rim 78 includes the body 160, the outer flanges 162, the inner flanges 164 and the brake ring 166.

The front brake unit 80 includes the brake housing 168, the brake cylinders 170, and the brake pads 172. The brake pads 172 selectively apply braking force to the front wheel rim 78 in conventional manner through the front hydraulic brake line 182.

A rear end 450 of the support frame 408 includes a pair of upper frame tubes 452 which bend rearwardly downwardly terminating at respective upper mounting ends 454 and a pair of lower frame tubes 456 which terminate rearwardly at respective lower mounting ends 458 welded to the upper mounting ends 454 with a transverse swing arm pivot tube 460. The lower frame tubes 456 are interconnected by a shock absorber mounting plate 462 with a pair of shock absorber mounting tabs 464.

The rear suspension 422 includes an annular rear wheel bearing 465, a swing arm 466 affixed thereto and pivotally mounted to the support frame 408 at the pivot tube 460, the rear shock absorber 194 pivotally mounted to the mounting tabs 464 of the shock absorber mounting plate 462 using a tenth pivot bolt 468 and to the swing arm 466 using an eleventh pivot bolt 470, and a spoked drive sprocket 471 mounted to the rear wheel bearing 465 to rotatably support a rear wheel rim 472 thereabout. The rear brake unit 208 is mounted to the rear wheel bearing 465 to selectively apply braking force to the rear wheel rim 472.

The rear wheel bearing 465 includes a pair of annular flange rings 474 and 476, a plurality of the roller bearings 226, and a plurality of the ball bearings 228. The flange ring 474 has an outer leg 478, an intermediate leg 480, and a base leg 482 which define a roller space 484 and a ball space 486. The flange ring 474 has an outer periphery 488 which fits within the rear wheel rim 472, an inner periphery 490 with a plurality of brake mounting pads 492 and a plurality of pads 494. The flange ring 476 has an outer leg 496 and a base leg 498 which define a ball space 500 and abuts the roller space 484. The flange ring 476 has an outer periphery 502 which fits within the rear wheel rim 472, an inner periphery 504 with a plurality of brake mounting pads 506 and pads 508. The flange rings 474 and 476 are connected together using a plurality of bolts 510 that extend through clearance holes 512 through the flange ring 474 and engage threaded holes 514 of the flange ring 476 to form an annular roller race 516 to contain the rollers 226 and annular ball races 518 and 519 to contain the ball bearings 228. The rear wheel bearing 465 is rigidly mounted to the swing arm 466 using a twelfth pivot bolt 520.

The rear wheel rim 472 includes an annular body 522 with an valve hole 523 therethrough, respective dependent annular outer flanges 524, a dependent annular inner flange 526 which abuts respective of the ball races 518 and 519 to retain the ball bearings 228 therein and abuts the roller race 516 to support the rear wheel rim 472, a dependent annular inner brake ring 528, and a dependent annular inner sprocket mounting flange 530 with a mounting shoulder 532. A valve stem 533 is mounted through the valve hole 523 to inflate the rear tire 426. The rear wheel rim 472 is made of cast aluminum that is machined to final configuration.

The drive sprocket 471 includes the sprocket plate ring 534, and mounting ring 536 connected thereto by a hub 538 and spokes 540. The sprocket plate ring 534 has a toothed outer periphery 542 which engages the drive chain 46 and an inner periphery 544 affixed to the hub 538. The mounting ring 536 has an outer periphery 546 which is connected to the mounting shoulder 532 using a plurality of bolts 548 that extend through respective clearance holes 550 thereof and engage respective threaded holes 552 of the rear wheel rim 472. The mounting ring 536 has an inner periphery 554 affixed to the spokes 540 which are affixed to the hub 538.

The rear brake unit 208 includes the brake housing 308, the brake cylinders 310, and the brake pads 312. The brake pads 312 selectively apply braking force to the rear wheel rim 472 in conventional manner through the rear hydraulic brake line 324.

The swing arm 466 includes a solid L-shaped body 558 having a horizontal leg 560 and a downwardly dependent vertical leg 562 with a pair of shock absorber mounting tabs 564. The swing arm 466 has the bushings 400 through a pivot bore 566 thereof to receive the tenth pivot bolt 468 which extends through the swing arm pivot tube 460. The rear wheel bearing 465 is mounted to the swing arm 466 using the a pair of mounting blocks 568.

The motorcycles and suspension systems of the present invention provides many advantages over prior art devices. These include: 1) saving about 75 to 100 lbs in weight of motorcycle over traditional suspension systems; 2) provides a lower center of gravity for better handling and safer operation; 3) the front suspension is much stronger than traditional front suspension systems; 4) provides better stability for highway use; 5) stronger than traditional suspension systems to provide improved crash survivability; 6) has less moving parts than traditional suspension systems with no parts of the frame moving providing increased reliability and lower manufacturing costs; 7) in a front impact the shock absorber dissipates some of the energy of impact providing a form of “crumple zone” as utilized in the sheet metal construction of automobiles; 8) resistant to the “suspension dive” phenomenon when the front brake is applied; 9) provides brake rings of increased diametere and surface area which provides increased leverage and cooling for more braking power; and 10) only a portion of the wheels move substantially when hitting irregularities in the ground surface rather than the whole wheel moving the same distance as in traditional suspension systems which provides a more responsive suspension system.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A centerless wheel assembly for motorcycles, comprising:
a ring-shaped wheel rim which includes an annular body and a pair of annular outer flanges radially outwardly dependent from the body which define an annular tire receiving outer surface; and
a ring-shaped wheel bearing rotatably retained within said wheel rim which together define an annular bearing race adapted to contain a plurality of bearing members to rotatably support said front wheel rim on said wheel bearing, said wheel bearing being adapted to mount to the motorcycle through a shock absorber of the motorcycle to allow upward and downward movement of the wheel assembly against the shock absorber responsive to road contours.

2. The wheel assembly according to claim 1, wherein the wheel bearing is adapted to mount to the motorcycle and allow movement of the wheel assembly in a manner chosen from the group consisting of fixedly mounted disposed closely adjacent to the wheel rim and operatively mounted to the shock absorber to allow linear movement, pivotally mounted at a main pivot disposed closely adjacent to the wheel rim and operatively mounted to the shock absorber at a secondary pivot to allow pivotal movement, fixedly mounted to a pivotable swing arm of the motorcycle disposed closely adjacent to the wheel rim that is operatively mounted to the shock absorber to allow pivotal movement, and fixedly mounted to a pivotable swing arm of the motorcycle disposed closely adjacent to the wheel rim that is adapted to operatively mount to the shock absorber at a secondary pivot to allow pivotal movement.

3. The wheel assembly according to claim 2, further comprising:
a brake unit which includes a brake housing adapted to transversely mount to the wheel bearing, at least one brake cylinder mounted to said housing operated through a hydraulic brake line of the motorcycle, and a pair of brake pads which straddle a brake ring radially inwardly dependent from the body of the wheel rim disposed in a lateral orientation on said wheel rim chosen from the group consisting of centered and offset that are operatively associated with said housing and said brake cylinders to selectively apply braking force to said brake ring of the wheel rim; and
wherein said wheel bearing includes a number of bearing ring pairs comprised of respective first and second bearing rings that connect together rotatably retained within said wheel rim with the bearing race and one of the plurality of bearing members disposed therebetween chosen from the group consisting of a single bearing ring pair and two bearing ring pairs, said wheel bearing which includes two of said bearing ring pairs being retained in a laterally spaced position using a plurality of spacers disposed therebetween, said wheel rim having an annular inner flange for each bearing ring pair radially inwardly dependent from said body adapted to closely fit at least partially disposed within respective of said bearing races to retain respective of said bearing members therein, said first and second bearing rings of each bearing ring pair being chosen from the group consisting of said first bearing ring comprising a plate ring of rectangular cross-section and said second bearing ring comprising a flange ring of L-shaped cross-section having an outer leg and a base leg which together with said plate ring defines the bearing race, and said first bearing ring comprising a flange ring of Z-shaped cross-section which includes an outer leg, an intermediate leg, and a base leg which together with the wheel rim defines an annular roller race adapted to contain a plurality of said bearing members in the form of rollers and the bearing race in the form of a ball race adapted to contain a plurality of said bearing members in the form of ball bearings and said second bearing ring comprising a flange ring of L-shaped cross-section which includes an outer leg and a base leg which together with said wheel rim define an annular second ball race abutting said roller race adapted to contain a plurality of said ball bearings.

4. The wheel assembly according to claim 1, wherein the wheel rim includes a brake ring radially inwardly dependent from the body thereof disposed in a lateral orientation on said wheel rim chosen from the group consisting of centered and offset.

5. The wheel assembly according to claim 4, further comprising a brake unit which includes a brake housing adapted to transversely mount to the wheel bearing, at least one brake cylinder mounted to said housing operated through a hydraulic brake line of the motorcycle, and a pair of brake pads which straddle the brake ring that are operatively associated with said housing and said brake cylinders to selectively apply braking force to said brake ring of the wheel rim.

6. The wheel assembly according to claim 5, wherein the wheel bearing has an inner periphery with at least one brake mounting pad radially inwardly dependent therefrom, the brake housing being adapted to slidably mount to each brake mounting pad to allow centering of the brake pads on the brake ring using a bolt which extends through a clearance hole through one of said brake mounting pad and said housing which is secured to another thereof in a manner chosen from the group consisting of engaging a threaded hole and extending through a clearance hole to engage a nut.

7. The wheel assembly according to claim 1, wherein the wheel bearing includes at least one bearing ring pair comprised of respective first and second bearing rings that connect together rotatably retained within the wheel rim with the bearing race and one of the plurality of bearing members disposed therebetween.

8. The wheel assembly according to claim 7, wherein the first and second bearing rings are connected together using a plurality of bolts that extend through respective clearance holes of one thereof and are anchored to another thereof in a manner chosen from the group consisting of engaging respective threaded holes and extending through respective clearance holes to engage respective nuts.

9. The wheel assembly according to claim 7, wherein the wheel bearing includes two of the bearing ring pairs which are retained in a laterally spaced position using a plurality of spacers disposed therebetween.

10. The wheel assembly according to claim 9, wherein the first and second bearing rings of each bearing ring pair have an inner periphery with a plurality of spacer pads radially inwardly dependent therefrom, said spacer pads of each being connected together using a plurality of bolts which extend through clearance holes of one thereof and are anchored to another thereof in a manner chosen from the group consisting of engaging threaded holes and extending through clearance holes to engage respective nuts.

11. The wheel assembly according to claim 7, wherein the wheel rim has an annular inner flange for each bearing ring pair radially inwardly dependent from the body adapted to closely fit at least partially disposed within respective of said bearing races to retain respective of said bearing members therein.

12. The wheel assembly according to claim 11, wherein each inner flange of the wheel rim and the bearing rings of each bearing ring pair include complementary facing grooves that form respective pairs of annular lateral bearing races adapted to contain respective pluralities of the bearing members to absorb lateral forces applied to the wheel bearing through the wheel rim.

13. The wheel assembly according to claim 11, wherein the first and second bearing rings of each bearing ring pair are of chosen from the group consisting of said first bearing ring comprising a plate ring of rectangular cross-section and said second bearing ring comprising a flange ring of L-shaped cross-section having an outer leg and a base leg which together with said plate ring defines the bearing race, and said first bearing ring comprising a flange ring of Z-shaped cross-section which includes an outer leg, an intermediate leg, and a base leg which together with the wheel rim defines an annular roller race adapted to contain a plurality of the bearing members in the form of rollers and the bearing race in the form of a ball race adapted to contain a plurality of said bearing members in the form of ball bearings and the second bearing ring comprising a flange ring of L-shaped cross-section which includes an outer leg and a base leg which together with said wheel rim define an annular second ball race abutting said roller race adapted to contain a plurality of said ball bearings.

14. The wheel assembly according to claim 1, further comprising a drive assembly which includes a mounting ring having an outer periphery adapted to connect to a mounting shoulder of the wheel rim and a drive ring coaxially affixed to said mounting ring in a laterally spaced relation thereto having an outer periphery of a type chosen from the group consisting of a toothed, a v-belt groove, or a toothed pulley groove adapted to engage a drive loop of the motorcycle respectively in the form of a chain, a v-belt, and a toothed drive belt to drive said wheel rim.

15. The wheel assembly according to claim 14, wherein the drive assembly includes a tubular hub to which an inner periphery of the drive ring is directly affixed and an inner periphery of the mounting ring is affixed through a plurality of radially extending spoke members, and a brake ring radially inwardly dependent from the mounting ring, the outer periphery of said drive assembly and the wheel rim being connected together using a plurality of bolts that extend through respective clearance holes of one thereof and are anchored to another thereof in a manner chosen from the group consisting of engaging respective threaded holes and extending through respective clearance holes to engage respective nuts.

16. A motorcycle, comprising:
a support frame which includes a front end with a steering bearing unit mounted thereto and a rear end;
a pair of handle bars upwardly dependent from a pivot post pivotally disposed through said bearing unit;
a front suspension which includes at least one fork tube downwardly dependent from said pivot post and at least one front shock absorber;
a rear suspension pivotally mounted to said rear end of said support frame which includes a rear shock absorber;
respective centerless front and rear wheel assemblies which include respective ring-shaped front and rear wheel rims each having an annular body and a pair of annular outer flanges radially outwardly dependent therefrom which define an annular tire receiving outer surface, and respective ring-shaped front and rear wheel bearings rotatably retained within respective of said front and rear wheel rims which together define respective annular front and rear bearing races adapted to contain respective pluralities of bearing members to rotatably support respective of said front and rear wheel rims on respective of said front and rear wheel bearings, said front and rear wheel bearings being respectively adapted to mount to said front fork tube through said front shock absorber and said rear end of said support frame through said rear shock absorber to respectively allow movement of said front and rear wheel assemblies thereagainst responsive to road contours;
respective front and rear tires mounted to said front and rear wheel rims at said tire receiving outer surfaces;
an engine with gear box centrally mounted to said support frame adapted to drive said rear wheel assembly and said rear tire through a drive assembly;
a hydraulic brake system which includes respective front and rear hydraulic brake lines;
a gas tank mounted to said support frame to supply fuel to said engine; and
a seat mounted to support frame for a rider to sit on.

17. The motorcycle according to claim 16, wherein the front suspension includes a pair of the fork tubes each of which comprise a pair of upper and lower fork tubes, said upper and lower fork tubes which telescope together straddling opposite sides of the front wheel assembly and the front tire, respective lower ends of said lower fork tubes being fixedly mounted to the front wheel bearing disposed closely adjacent to the front wheel rim, and there are a pair of the front shock absorbers at least a portion of each being disposed within respective of said pairs of fork tubes having opposite ends connected to said upper and lower fork tubes of said fork tube pair to allow generally vertically oriented linear movement of the front wheel assembly responsive to road contours that is controlled by said front shock absorbers.

18. The motorcycle according to claim 17, wherein the lower ends of the lower fork tubes are affixed to the front wheel bearing in a manner chosen from the group consisting of directly by inwardly bending and at least partially flattening said lower ends which are affixed directly to the front wheel bearing, and indirectly using at least one mounting block affixed to said lower ends and to said front wheel rim.

19. The motorcycle according to claim 16, wherein the front suspension includes a support fender comprised of a curved outer wall closely disposed radially outwardly of the front tire and a pair of dependent side walls laterally disposed along said front tire, said outer wall is adapted to pivotally connect to a first end of the front shock absorber and said front suspension is adapted to pivotally connect to a second end thereof, each of said side walls having a main pivot and a secondary pivot respectively coaxially disposed through respective lower and an upper ends thereof, the front wheel bearing having main and secondary pivots disposed closely adjacent to the front wheel rim, and said main pivots of each pivotally connect together and said secondary pivots connect together to allow generally vertically oriented pivotal movement of the support fender and the front wheel assembly responsive to road contours that is controlled by said front shock absorber.

20. The front suspension system according to claim 19, wherein the side walls of the support fender comprise respective pairs of upper and lower tabs respectively having the secondary and main pivots.

21. The front suspension system according to claim 19, wherein the main and secondary pivots of the support fender, the front wheel bearing, and the fork tubes comprise respective main and secondary mounting holes adapted to receive respective main and secondary mounting fasteners.

22. The motorcycle according to claim 19, wherein the front suspension includes a pair of the fork tubes interconnected by a mounting member to which the second end of the front shock absorber is pivotally connected, said fork tubes which terminate at respective lower ends having a pair of the main pivots coaxially disposed therethrough.

23. The motorcycle according to claim 19, wherein the front suspension includes a front extension which extends forwardly from the front end of the support frame, the fork tube includes an upper end connected to the pivot post through a first universal joint, a steering yoke of generally Y-shape is disposed generally horizontally at said front extension which includes a base leg pivotally connected thereto using a bearing and a pair of dependent forked legs that straddle opposite sides of the front wheel assembly, said lower end of said fork tube being connected to said base of said steering yoke through a second universal joint coaxial with said bearing, the second end of the front shock absorber being pivotally connected to said steering yoke, and said forked legs which terminate at respective distal ends having a pair of the main pivots coaxially disposed therethrough.

24. The motorcycle according to claim 16, wherein the rear suspension includes a pivoting swing arm having a front end pivotally mounted to the rear end of the support frame at respective main pivots of each extending generally horizontally rearwardly along a side of said rear wheel assembly opposite the drive assembly and having a rear end fixedly mounted to the rear wheel bearing disposed closely adjacent to the rear wheel rim, and said swing arm being adapted to pivotally connect to a first end of the rear shock absorber and said rear end of said support frame being adapted to pivotally connect to a second end thereof to allow generally vertically oriented pivotal movement of said rear swing arm and said rear wheel assembly responsive to road contours that is controlled by said rear shock absorber.

25. The motorcycle according to claim 24, wherein the main pivots of the swing arm and the rear end of the support frame comprise respective mounting holes adapted to receive a mounting fastener, said swing arm includes at least one mounting tab which extends generally upwardly therefrom for pivotally connecting to a mounting tab of the first end of the rear shock absorber using a first shock mounting fastener which extends through respective mounting holes thereof, and said rear end of said support frame includes at least one mounting tab which extends therefrom for pivotally connecting to a mounting tab of the second end of said rear shock absorber using a second shock mounting fastener which extends through respective mounting holes thereof.

26. The motorcycle according to claim 24, wherein the swing arm is of a configuration chosen from the group consisting of straight and angled, said straight configuration comprising a first version pivot arm having the front end pivotally mounted to the support frame, the rear end fixedly mounted to the rear wheel bearing, said pivot arm being adapted to pivotally connect to the rear shock absorber, and said angled configuration comprising a second version pivot arm having the front end pivotally mounted to the support frame, the rear end fixedly mounted to the rear wheel bearing, a drive arm dependent therefrom at an angle adapted to pivotally connect to the rear shock absorber.

27. The motorcycle according to claim 16, wherein the rear wheel bearing has respective main and secondary pivots disposed closely adjacent to the rear wheel rim, a rear extension of the rear suspension extends rearwardly from the rear end of the support frame along a side of said rear wheel assembly opposite the drive assembly that is pivotally mounted to said main pivot of said rear wheel bearing at a lower frame pivot, the rear shock absorber extends along said side of said rear wheel assembly above said drive assembly having a first end that is pivotally mounted to said secondary pivot of said rear wheel bearing and a second end that is pivotally mounted to a part of the motorcycle chosen from the group consisting of said rear end of said support frame and said rear extension of said rear suspension at an upper frame pivot disposed generally above said lower frame pivot.

28. The motorcycle according to claim 27, wherein the main and secondary pivots of the rear wheel bearing and the rear extension of the support frame comprise respective main and secondary mounting holes adapted to receive respective main and secondary mounting fasteners.

29. The motorcycle according to claim 16, further comprising a pair of brake units which include respective brake housings adapted to transversely mount to respective of the front and rear wheel bearings, at least one brake cylinder mounted to each housing operated through respective of the front and rear hydraulic brake lines, and respective pairs of brake pads which straddle respective front and rear brake rings respectively radially inwardly dependent from the bodies of the front and rear wheel rims disposed in a lateral orientation on said wheel rims chosen from the group consisting of centered and offset that are operatively associated with said housings and said brake cylinders to selectively apply braking force to respective of said front and rear brake rings of said front and rear wheel rims.

30. A suspension system for motorcycles of the type having a support frame which includes a front end with a steering bearing unit mounted thereto and a rear end, a pair of handle bars upwardly dependent from a pivot post pivotally disposed through the bearing unit, respective front and rear tires, an engine with gear box centrally mounted to the support frame to drive the rear tire through a drive assembly, a hydraulic brake system which includes respective front and rear hydraulic brake lines, a gas tank mounted to the support frame to supply fuel to the engine, and a seat mounted to support frame for a rider to sit on, the suspension system comprising:
respective centerless front and rear wheel assemblies which include respective ring-shaped front and rear wheel rims each having an annular body and a pair of annular outer flanges radially outwardly dependent therefrom which define an annular tire receiving outer surface, and respective ring-shaped front and rear wheel bearings rotatably retained within respective of said front and rear wheel rims which together define respective annular front and rear bearing races adapted to contain respective pluralities of bearing members to rotatably support respective of said front and rear wheel rims on respective of said front and rear wheel bearings, the front and rear tires being respectively mounted to said front and rear wheel rims at said tire receiving outer surfaces with the engine with gear box which drive said rear wheel assembly through the drive assembly;
a front suspension which includes at least one fork tube downwardly dependent from said pivot post and at least one front shock absorber in numbers of each chosen from the group consisting of a pair of said fork tubes and said front shock absorbers, a pair of said fork tubes and one of said front shock absorbers, and one each of said fork tubes and said front shock absorber, said front suspension which includes a pair of each of said fork tubes and said front shock absorbers having each fork tube comprising an upper fork tube and a lower fork tube which telescope together straddling opposite sides of said front wheel assembly with respective lower ends of said lower fork tubes being fixedly mounted to said front wheel bearing disposed closely adjacent to said front wheel rim with at least a portion of each front shock absorber being disposed within respective of said pair of fork tube pairs having opposite ends connected to said upper and lower fork tubes to allow generally vertically oriented linear movement of said front wheel assembly responsive to road contours that is controlled by said front shock absorbers, said front suspensions which includes a pair of said fork tubes and one of said front shock absorbers and which includes one each of said fork tube and said front shock absorber each including a support fender comprised of a curved outer wall closely disposed radially outwardly of the front tire and a pair of dependent side walls laterally disposed along the front tire with said outer wall adapted to pivotally connect to an end of the front shock absorber with each of said side walls having a main pivot and a secondary pivot respectively coaxially disposed through respective lower and an upper ends thereof with said front wheel bearings having main and secondary pivots disposed closely adjacent to said front wheel rim and said main pivots of each pivotally connect together and said secondary pivots connect together to allow generally vertically oriented pivotal movement of the support fender and the front wheel assembly responsive to road contours that is controlled by said front shock absorber, said front suspension which includes a pair of said fork tubes and one of said front shock absorbers having said fork tubes being interconnected by a mounting member to which an end of said front shock absorber is pivotally connected with respective lower ends of said fork tubes having a pair of the main pivots coaxially disposed therethrough, said front suspension which includes one each of said fork tube and said front shock absorber having a front extension which extends forwardly from the front end of the support frame with said fork tube which includes an upper end connected to the pivot post through a first universal joint and a steering yoke of generally Y-shape disposed generally horizontally at said front extension which includes a base leg pivotally connected thereto using a bearing and a pair of dependent forked legs that straddle opposite sides of said front wheel assembly with said lower end of said fork tube being connected to said base of said steering yoke through a second universal joint coaxial with said bearing and another end of said front shock absorber being pivotally connected to said steering yoke and said forked legs which terminate at respective distal ends having a pair of the main pivots coaxially disposed therethrough; and
a rear suspension pivotally mounted to said rear end of said support frame which includes a rear shock absorber and said rear wheel assembly is pivotally connected to the support frame in a manner chosen from the group consisting of through a pivoting swing arm and directly to the rear of the support frame, said rear suspension which is pivotally connected to the support frame through the pivoting swing arm which has a front end pivotally mounted to the rear end of the support frame at respective main pivots of each extending generally horizontally rearwardly along a side of said rear wheel assembly opposite the drive assembly and having a rear end fixedly mounted to said rear wheel bearing disposed closely adjacent to said rear wheel rim with said swing arm being adapted to pivotally connect to an end of the rear shock absorber and the rear end of the support frame being adapted to pivotally connect to a second end thereof to allow generally vertically oriented pivotal movement of said rear swing arm and said rear wheel assembly responsive to road contours that is controlled by said rear shock absorber, said swing arm being of a configuration chosen from the group consisting of straight and angled, said straight configuration comprising a first version pivot arm having the front end pivotally mounted to the support frame with said rear end fixedly mounted to said rear wheel bearing and said pivot arm being adapted to pivotally connect to said rear shock absorber, and said angled configuration comprising a second version pivot arm having said front end pivotally mounted to the support frame with said rear end fixedly mounted to said rear wheel bearing with a drive arm dependent therefrom at an angle adapted to pivotally connect to said rear shock absorber, said rear suspension which is pivotally connected directly to the rear of the support frame having said rear wheel bearing with respective main and secondary pivots disposed closely adjacent to said rear wheel rim with a rear extension which extends rearwardly front the rear end of the support frame along a side of said rear wheel assembly opposite said drive assembly that is pivotally mounted to said main pivot of said rear wheel bearing at a lower frame pivot and said rear shock absorber extends along said side of said rear wheel assembly above said drive assembly having an end that is pivotally mounted to said secondary pivot of said rear wheel bearing and a second end that is pivotally mounted to a part of said support frame chosen from the group consisting of said rear end and said rear extension of said support frame at an upper frame pivot disposed generally above said lower frame pivot.
